(19) United States
(12) Patent Application Publication
(10) Pub. No.: US 2007/0085319 A1
(43) Pub. Date: Apr. 19, 2007

(54) SEAT-BELT TENSIONER

(75) Inventors: Walter Scherzinger, Ulm (DE); Roland Schnabl, Ulm (DE); Thomas Schwer, Illertissen (DE)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/530,355

(22) Filed: Sep. 8, 2006

Related U.S. Application Data
(63) Continuation of application No. PCT/DE05/00446, filed on Mar. 8, 2005.

(30) Foreign Application Priority Data
Mar. 9, 2004 (DE) 10 2004 012 173.4

(51) Int. Cl. B60R 22/46

(52) U.S. Cl. 280/806

(57) ABSTRACT

A seat-belt tensioner with a drive motor and a gear connected to the drive motor for tensioning a seat belt. The disclosed arrangement includes an overload clutch arranged between the gear and the seat-belt spindle. The overload clutch transmits torques up to a predetermined maximum torque and disengages when the maximum torque is exceeded.

### CROSS REFERENCE TO RELATED APPLICATIONS

This is a continuation of International Application PCT/DE2005/000446, which has an international filing date of Mar. 8, 2005; this International Application was not published in English, but was published in German as WO W2005/087553.

### BACKGROUND

The invention relates to a seat-belt tensioner having a drive motor and a gear which is connected to the drive motor for tensioning a seatbelt.

A seat-belt tensioner of this type is disclosed, for example, in German Patent Document DE 197 31 689 A1 (incorporated by reference herein). The disclosed seat-belt tensioner has a gear which can be directed into different shift positions as a function of sensor signals. The gear is controlled by an electronic control device processing the data of the sensor signals.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 shows a perspective view of an exemplary embodiment of a seat belt tensioner for tensioning a seat belt.

FIG. 2 shows a first force transmission path according to a disclosed embodiment.

FIG. 3 shows the operation of a sliding clutch formed by a pawl carrier, a disk cam, and a coupling wheel in the disengaged position.

FIG. 4 shows a torsion spring that is fastened on the pawl carrier for biasing the disk cam.

FIG. 5 is a detailed view of a spindle clutch.

FIG. 6 shows the seat belt spindle together with the spindle clutch after the installation on the installation plate.

FIG. 7 is a detailed view of a planetary gear.

FIG. 8 shows a view of a blocking device in conjunction with a connecting gearwheel according to a disclosed embodiment.

FIG. 9 is a lower view of the blocking device in conjunction with the connecting gearwheel with a latching pawl in the first pawl position.

FIG. 10 is an upper view of the blocking device in conjunction with the gearwheel with the latching pawl in the second pawl position.

FIG. 11 shows an overload clutch arranged between the pawl teeth of the seat belt spindle and the seat belt spindle according to a disclosed embodiment.

FIG. 12 shows an embodiment in which the rotation of the motor pinion, the connecting gearwheel, the coupling wheel, and the spindle clutch toothed ring during activation of the drive motor.

FIG. 13 shows the resultant position of the latching pawl, disk cam, and sliding clutch pawl after the predetermined seat belt-extraction force has been exceeded in an accident scenario.

FIG. 14 shows the return position of the connecting rod, friction element, the latching pawl, and disk cam after the predetermined seat belt-extraction force has been exceeded in an accident scenario.

FIG. 15 shows the connecting rod, the friction element, and the latching pawl from FIG. 14 in detail.

### DESCRIPTION

According to a disclosed embodiment, an overload clutch is arranged between the gear and the seat-belt spindle and transmits torques up to a predetermined maximum torque and, when the maximum torque is exceeded, disengages.

A significant advantage of the disclosed seat-belt tensioner results from the fact that, in the event of a vehicle accident, the gear will not be destroyed by the high seat-belt-restraining forces occurring because of the accident; this is because the overload clutch avoids critical or excessive torques being transmitted by the seat-belt spindle to the gear. It is thus ensured that the seat-belt tensioner operates reliably even in dangerous situations.

The overload clutch is preferably formed by two coupling elements which form a force-locked connection between the gear and the seat-belt spindle. The force-locked connection is designed so that it is automatically canceled when the predetermined maximum torque is exceeded.

In a particularly simple and therefore advantageous manner, the overload clutch can be formed by tapering coupling elements; specifically, the first coupling element is formed, for example, by an internal taper and the second coupling element is formed by an external taper which is held in a force-locked manner in the internal taper.

It is regarded as advantageous if the seat-belt tensioner is completely reversible. A reversible seat-belt tensioner makes it possible to use the latter, after a first accident event, in which the seat belt has been tensioned for a first time by the seat-belt tensioner, to tension the seat belt one or more further times. A reversible seat-belt tensioner is therefore also capable of use in the case of what is referred to as a “second impact” (or further accident events).

In the context of an advantageous development of the seat-belt tensioner, it is provided that the gear is a mechanical automatic gear and shifts automatically as a function of load.

One advantage of a mechanical automatic gear consists in that the latter does not require an additional electric control device which causes the gear to shift; this is because the mechanical automatic gear is shifted automatically as a function of load. In addition, a mechanical automatic gear manages without electric displacement elements, for example solenoids or pyrotechnic actuating elements, since, as already mentioned, it automatically shifts mechanically.

The automatic gear preferably has at least two speeds and has a first force transmission path for a first speed with a first transmission ratio and at least one further force transmission path for a second speed and a transmission ratio which is larger than the first transmission ratio. The automatic gear preferably has a connecting gearwheel which is driven by the drive motor of the seat-belt tensioner and interacts both with the first and with the second force transmission path.

A shifting from the first force transmission path to the second force transmission path can be achieved in a particularly simple and therefore advantageous manner if the first force transmission path comprises a sliding clutch which disengages when a predetermined switching-off moment is exceeded, so that the further force transmission path is activated. The predetermnined switching-off moment of the sliding clutch is preferably dimensioned so that it corresponds to a seat-belt force on the shoulder of the vehicle occupant of between 200 and 250 newtons.

The first force transmission path can be formed in a cost-effective and therefore advantageous manner by the sliding clutch, a coupling wheel connected to the sliding clutch and a spindle clutch toothed ring connected to the seat-belt spindle and the coupling wheel.

The sliding clutch preferably has a pawl carrier which is mounted rotatably coaxially with the connecting gearwheel; a sliding clutch pawl is preferably mounted pivotably on the pawl carrier so that it can be pivoted into a coupling position and into a disengaging position. In its coupling position, the sliding clutch pawl couples the pawl carrier and the connecting gearwheel; in its disengaging position, it is ineffective with regard to the coupling between the connecting gearwheel and the pawl carrier.

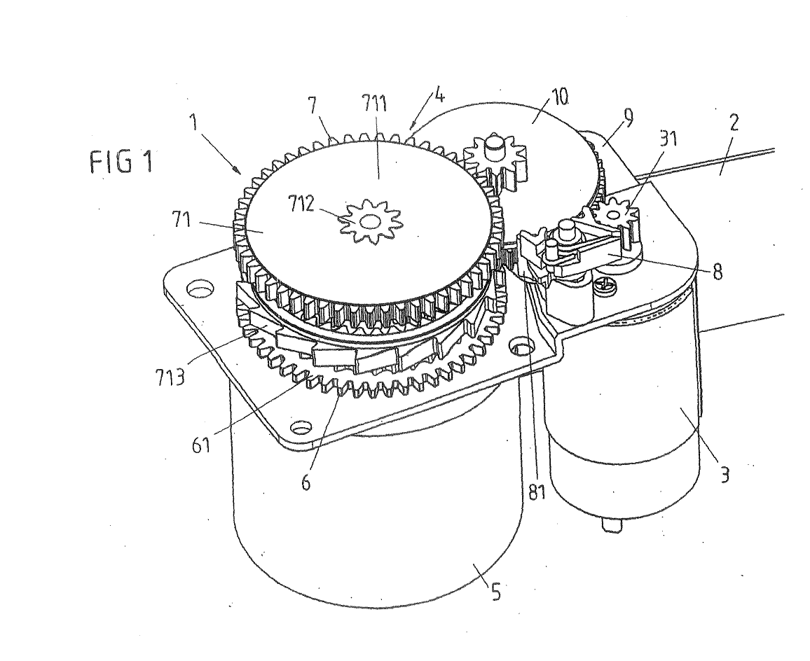

The term “seat-belt-tensioning direction of rotation” below indicates that direction of rotation in which the seat belt is retracted and is therefore tensioned. With regard to the direction of rotation, it is focused on the action which the particular rotation has on the seat belt: for example, in the case of the exemplary embodiment explained in conjunction with FIGS. 1 to 13, the drive motor and the seat-belt spindle always rotate, because of the automatic gear, in opposed directions of rotation; nevertheless, they each both have the “seat-belt-tensioning direction of rotation” during the tensioning of the seat belt. In a corresponding manner, the term “seat-belt-unrolling direction” below is understood as meaning the opposed direction of rotation, in which the seat belt is unrolled from the seat-belt spindle.

The sliding clutch preferably has a disk cam which prevents the sliding clutch pawl, after it has reached its disengaging position, from automatically passing again into the coupling position. This has the effect that, after the automatic gear has shifted up from the first speed into the second speed—i.e. from the first force transmission path to the second force transmission path—a shifting back from the second speed to the first speed is prevented as long as such a shifting back is not desired and permitted.

The disk cam and the pawl carrier can be rotated, for example, by a predetermined angle of rotation relative to each other. As soon as the sliding clutch pawl has reached its disengaging position, the disk cam is preferably rotated by a spring into a blockade position in which it holds the sliding clutch pawl in the disengaging position and prevents the sliding clutch pawl from being reinserted into the connecting gearwheel.

In addition to the sliding clutch pawl already mentioned—called “first” sliding clutch pawl below—the sliding clutch preferably has a second sliding clutch pawl. The function of the second sliding clutch pawl is to assist the first sliding clutch pawl in the force transmission. The two sliding clutch pawls are preferably engaged and disengaged together. The second sliding clutch pawl can be mounted pivotably, for example, on the pawl carrier.

The two sliding clutch pawls are preferably in each case preloaded in the insertion direction—with respect to the connecting wheel. For cost reasons, this preloading of the two sliding clutch pawls is brought about by one and the same pivoting spring.

The seat-belt spindle and the automatic gear are preferably connected to each other with a spindle clutch. The spindle clutch is preferably configured so that it engages when the drive motor rotates in the seat-belt-tensioning direction of rotation and disengages with freedom from load when the drive motor rotates in the seat-belt-unrolling direction of rotation.

The spindle clutch preferably has spindle clutch pawls which are arranged so that they are inserted into pawl teeth of the seat-belt spindle as soon as the spindle clutch toothed ring rotates in the seat-belt-tensioning direction of rotation. As a result, the seat-belt spindle and the spindle clutch toothed ring couple to each other in a rotationally fixed manner.

In addition, the spindle clutch pawls are preferably arranged so that they are pivoted out of the pawl teeth of the seat-belt spindle as soon as the spindle clutch toothed ring rotates in the seat-belt-unrolling direction and there is freedom from load. By means of such a pivoting-out of the spindle clutch pawls, the coupling connection between the seat-belt spindle and the spindle clutch toothed ring can be separated, so that the seat-belt spindle can subsequently be rotated freely again. In other words, the spindle clutch pawls therefore only couple in the seat-belt-tensioning direction of rotation, but not in the seat-belt-unrolling direction.

In order to ensure that the spindle clutch pawls are inserted completely into the pawl teeth of the seat-belt spindle, the spindle clutch preferably has a synchronization pawl which is inserted into the pawl teeth of the seat-belt spindle. The seat-belt spindle and the spindle clutch toothed ring are thereby aligned with each other before the spindle clutch pawls engage in the pawl teeth of the seat-belt spindle. The function of the synchronization pawl is therefore to force a predetermined relative position between the spindle clutch toothed ring and the spindle clutch pawls before the spindle clutch pawls can be inserted into the pawl teeth of the seat-belt spindle.

The spindle clutch pawls and the synchronization pawl are preferably held pivotably in or on a spindle clutch housing which is aligned coaxially with the seat-belt spindle and is mounted rotatably in relation to the seat-belt spindle. The spindle clutch housing may be, for example, of two-part design and may have a spindle clutch carrier and a planet carrier connected thereto.

If the automatic gear has a planetary gear, it is regarded as advantageous if the spindle clutch housing has at least one fastening point for the rotatable fastening of at least one planet wheel of the planetary gear. For example, the spindle clutch housing can have three fastening points for three planet wheels. The fastening points for the planet wheels may be formed, for example, by pins on which the planet wheels of the planetary gear are rotatably mounted.

A planetary gear is preferably arranged in the further force transmission path. The planetary gear preferably revolves in a manner free from force transmission when the sliding clutch is engaged and, only when the sliding clutch is disengaged, is it used for the force transmission. The planetary gear then provides the second speed of the gear.

In order to make it possible for the planetary gear to revolve in a manner free from force transmission, said planetary gear preferably has a crown wheel which is driven by at least one planet wheel. An internal sun wheel serves, for example, to drive the at least one planet wheel. An external sun wheel, for example, which is driven by the connecting gearwheel is connected to the internal sun wheel. The internal and the external sun wheels may be formed by two separate wheels; as an alternative, the two sun wheels may also be formed by an integral wheel.

The planetary gear preferably has a planetary clutch pawl which interacts with the crown wheel and permits a rotation of the crown wheel along a predetermined crown-wheel direction of rotation and blocks a rotation of the crown wheel counter to the predetermined crown-wheel direction of rotation. The revolving of the planetary gear in a manner free from transmission when the sliding clutch is engaged, and the force transmission when the sliding clutch is disengaged can therefore be ensured with the planetary clutch pawl.

In order to activate the planetary clutch pawl, the latter is pivoted toward the crown wheel, for example, by a planetary clutch pawl spring.

In order to make it possible for the seat-belt spindle to be locked in the tensioned position after the end of the tensioning operation carried out with the seat-belt tensioner, the seat-belt tensioner preferably has a blocking device. A blocking device of this type makes it possible to switch off the drive motor after the end of the tensioning operation in order to avoid an overheating of the motor and also a permanent electric load on the electric system.

The blocking device is preferably configured so that it can be released without increasing the seat-belt-restraining force acting on the vehicle occupant. The blocking device can preferably be released by the drive motor of the seat-belt tensioner, for example by the drive motor being operated in the seat-belt-unrolling direction.

A blocking device of this type can be realized in a particularly simple and therefore advantageous manner by means of a latching pawl which can be brought both into a first and into a second pawl position. In the first pawl position, the latching pawl blocks the seat-belt spindle in the seat-belt-unrolling direction, and, in its second pawl position, it releases the seat-belt spindle in the seat-belt-unrolling direction.

The latching pawl is preferably held pivotably and resiliently, so that the latching pawl can be shifted from the first pawl position to the second pawl position and vice versa. The latching pawl is preferably held so that, when there is a predetermined seat-belt-extraction force, said latching pawl is pivoted from the first pawl position into the second pawl position. Such a pivoting-away of the latching pawl causes the seat-belt spindle to be released in the seat-belt-unrolling direction; an unrolling of the seat belt from the seat-belt spindle is therefore possible, so that the seat-belt force acting on the vehicle occupant who is to be protected by the seat belt can be restricted. The unrolling of the seat belt is preferably controlled or predetermined by a separate seat-belt-force restrictor, for example a torsion bar. As an alternative or in addition, the unrolling of the seat belt may also be controlled by the drive motor of the seat-belt tensioner.

The predetermined seat-belt-extraction force, at which the latching pawl is shifted from the first pawl position into the second pawl position, is preferably between 1000 and 3000 newtons, for example 2000 newtons (with regard to the seat-belt force at the shoulder height of the vehicle occupant).

In order, after the latching pawl is shifted from the first pawl position to the second pawl position, to be able to “reactivate” the seat-belt tensioner again, the latching pawl is configured so that it can be moved back again from the second pawl position into the first pawl position. The latching pawl is preferably held pivotably and resiliently so that it can be pivoted back from the second pawl position into the first pawl position solely with the aid of the driving force of the drive motor.

If the seat belt has been tensioned with the seat-belt tensioner without subsequently an accident actually happening and without the latching pawl having been brought into the second pawl position, then the blocking device can advantageously also be unblocked in a corresponding manner by the drive motor by the latching pawl being displaced by the drive motor from the first pawl position into the second pawl position. The “release peak” occurring in the case of previously known seat-belt tensioners therefore does not occur.

The latching pawl can be held pivotably, for example in accordance with a toggle-lever principle, in order to permit it to be pivoted from the first into the second pawl position and vice versa.

As an alternative, the pivot pin of the latching pawl may be arranged in an elongated hole of the latching pawl so that the latching pawl can be pivoted in a direction of rotation about the pivot pin and can be deflected radially to the pivot pin along the guide slot formed by the elongated hole.

At least one latching pawl spring which pivots the latching pawl toward the connecting gearwheel preferably interacts with the latching pawl.

FIGS. 1 to 15 show an exemplary embodiment for a seat-belt tensioner.

A seat-belt tensioner 1 for tensioning a seat belt 2 is seen in FIG. 1. The seat-belt tensioner has a drive motor 3 which is connected by its motor pinion 31 to an automatic gear 4. The automatic gear 4 is also connected to a seat-belt spindle 5 as a seat-belt roller.

Of the automatic gear 4, FIG. 1 shows a connecting gearwheel 10 which is connected to a first force transmission path 6 and a second force transmission path 7 of the automatic gear 4.

Of the first force transmission path 6, FIG. 1 shows a spindle clutch toothed ring 61 which is coupled to the connecting gearwheel 10.

Of the second force transmission path 7, FIG. 1 shows a planetary gear or planet wheel gear 71 with an external sun wheel 711. The external sun wheel 711 is in engagement with the connecting gearwheel 10. An internal sun wheel 712 which interacts with planet wheels (not visible in FIG. 1) is connected to the external sun wheel 711. The planet wheel gear 71 also has a crown wheel 713, the operation of which will be explained further below.

FIG. 1 also shows a blocking device 8 with a latching pawl 81. The blocking device 8 blocks the connecting gearwheel 10 after seat-belt tensioning has taken place, so that the drive motor 3 can be switched off. After seat-belt tensioning has taken place, the blocking device 8 can be deactivated again by the drive motor 3 being switched at least temporarily into the seat-belt-unrolling direction.

The drive motor 3 and the automatic gear 4 are mounted on an installation plate 9.

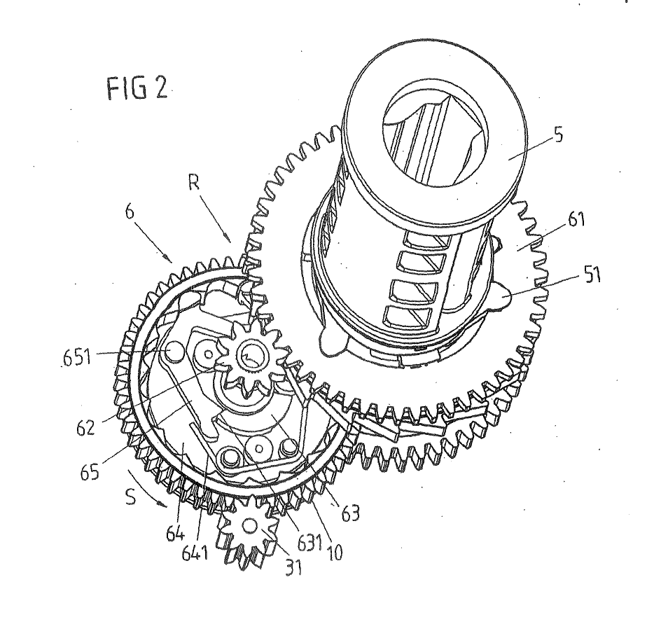

FIG. 2 illustrates the first force transmission path 6 in detail. It shows the spindle clutch toothed ring 61 which is connected to the seat-belt spindle 5 via a spindle clutch 51. The spindle clutch toothed ring 61 is also in engagement with a coupling wheel 62.

The disk cam 63 is fitted rotatably on a pawl carrier 64 which is arranged coaxially with the connecting gearwheel 10. The pawl carrier 64 and the connecting gearwheel 10 are mounted rotatably relative to each other. The coupling wheel 62 is connected in a rotationally fixed manner to the pawl carrier 64, for example by means of a claw clutch.

A first sliding clutch pawl 65 is mounted pivotably about a pivot pin 651 on the pawl carrier 64. The sliding clutch pawl 65 is deflected by means of a pivoting spring 641, which is fastened on the pawl carrier 64, so that it is in engagement with internal teeth of the connecting gearwheel 10. In this case, the sliding clutch pawl 65 is aligned so that a force transmission occurs between the connecting gearwheel 10 and the pawl carrier 64 along the seat-belt-tensioning direction of rotation of the seat-belt tensioner 1. The seat-belt-tensioning device is identified in FIG. 2 by the designation S.

It can be seen in FIG. 2 that the disk cam 63 has a cam 631 which interacts with the sliding clutch pawl 65. The function of the cam 631 is to bear against the sliding clutch pawl 65 if the sliding clutch R formed by the sliding clutch pawl 65, the pawl carrier 64 and the disk cam 63 is engaged.

In the position (illustrated in FIG. 2) of the sliding clutch pawl 65, a direct force transmission takes place between the motor pinion 31, the connecting gearwheel 10, the coupling wheel 62, the spindle clutch toothed ring 61 and the seat-belt spindle 5, since the spindle clutch 51 is engaged. The operation of the spindle clutch 51 will be explained further below.

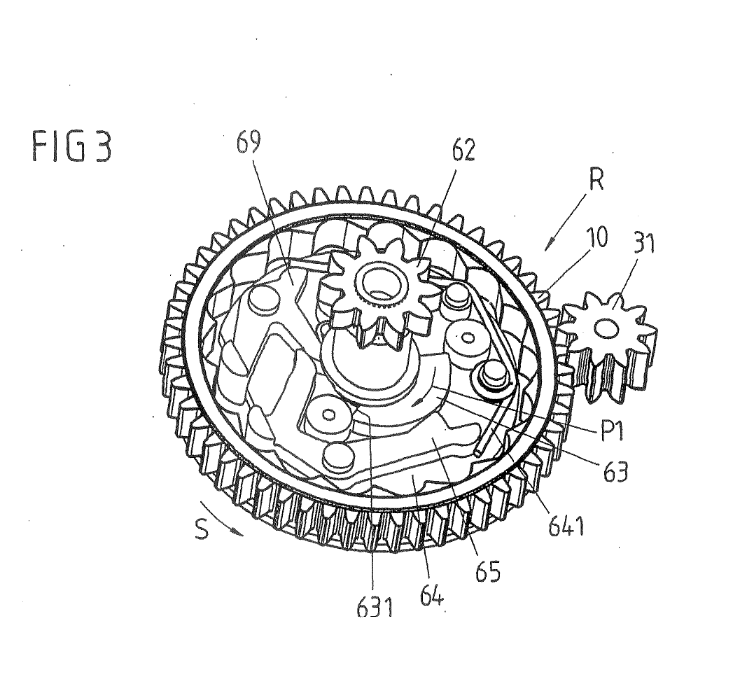

The operation of the sliding clutch R formed by the pawl carrier 64, the disk cam 63 and the coupling wheel 62 is shown in FIG. 3 once again in a detailed illustration: as soon as the torque to be transmitted exceeds a predetermined load moment during a rotational movement along the seat-belt-tensioning direction S, the sliding clutch disengages by the sliding clutch pawl 65 being pivoted inward counter to the spring force of the pivoting spring 641. When a pivoting movement of this type occurs, the disk cam 63 will rotate along the arrow direction P1 relative to the pawl carrier 64, so that the cam 631 is guided past the sliding clutch pawl 65. In the state illustrated in FIG. 3, the sliding clutch R is therefore disengaged, since the sliding clutch pawl 65 has passed into its disengaging position.

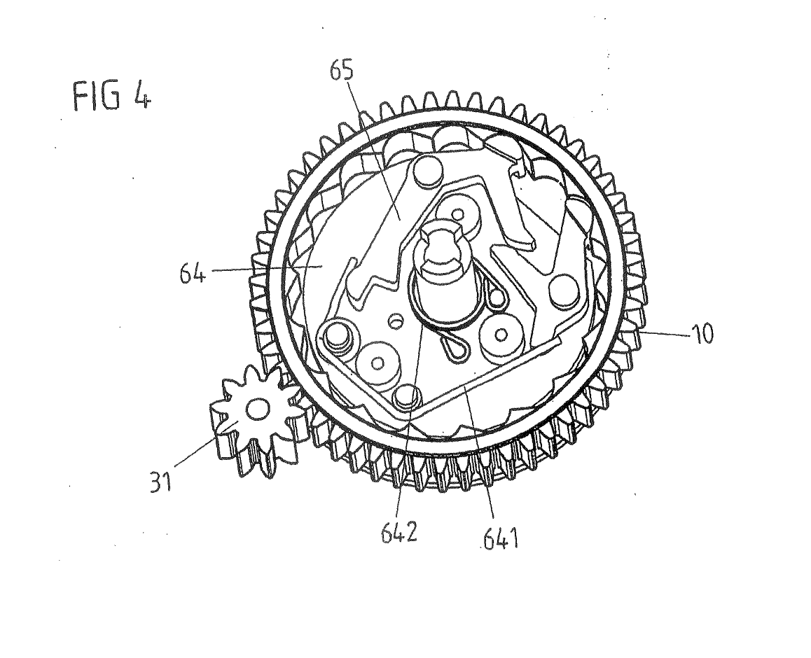

FIG. 4 shows a torsion spring 642 which is fastened on the pawl carrier 64 and places the disk cam 63 (not shown in FIG. 4) under a preload on the pawl carrier 64. Owing to the torsion spring 642, the disk cam 63 is rotated along the direction of rotation P1 illustrated in FIG. 3 as soon as the sliding clutch pawl 65 has passed into its disengaging position.

Rotation of the disk cam 63 with the cam 631 achieves the effect that the sliding clutch pawl 65, after it has reached its disengaging position illustrated in FIG. 3, can no longer automatically pass again into the coupling position. The sliding clutch pawl 65 therefore remains disengaged after a disengagement has taken place.

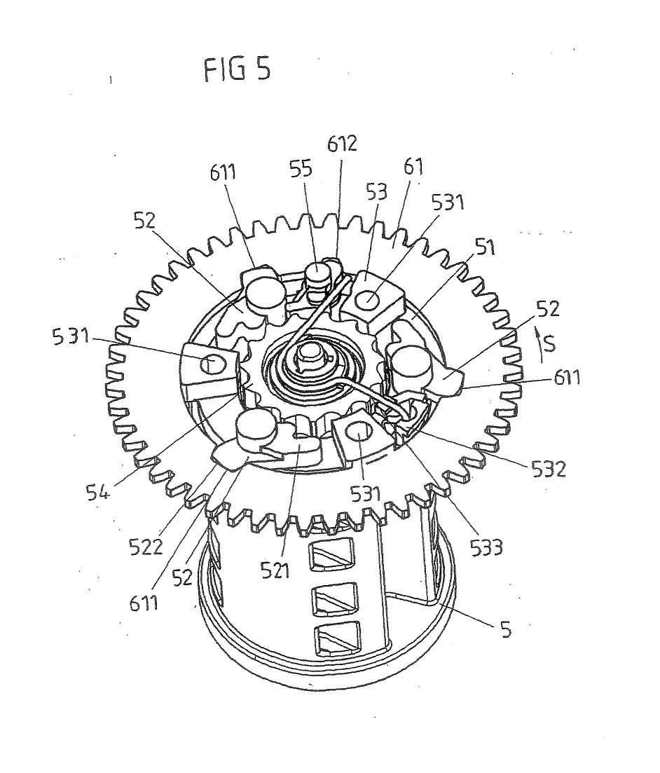

In FIG. 5, the spindle clutch 51, already mentioned in conjunction with FIG. 2, of the seat-belt spindle 5 is shown in detail. Three spindle clutch pawls 52 which are held pivotably in a spindle clutch housing 53 can be seen. Each of the three spindle clutch pawls 52 has in each case an external cam 522 which is always guided in an associated, inside-edge recess 611 in the spindle clutch toothed ring 61.

In addition, each of the spindle clutch pawls 52 has two inner claws 521 which engage in pawl teeth 54 of the seat-belt spindle 5. The pawl teeth 54 of the seat-belt spindle 5 are connected integrally, for example, to the seat-belt spindle 5. As can be gathered from FIG. 5, when the spindle clutch toothed ring 61 is driven in the seat-belt-tensioning direction of rotation S, the internal claws 521 will engage in the pawl teeth 54 of the seat-belt spindle 5, so that a coupling between the seat-belt spindle 5 and the spindle clutch toothed ring 61 comes about.

A synchronization pawl 55 can also be seen in FIG. 5. The function of the synchronization pawl 55 is to bring about a coupling between the seat-belt spindle 5 and the spindle clutch toothed ring 61 before the spindle clutch pawls 52 pivot in in the direction of the pawl teeth 54 of the seat-belt spindle 5 and engage. The synchronization pawl 55 therefore brings about an adjustment of the spindle clutch pawls 52 with respect to the pawl teeth 54 of the seat-belt spindle 5, so that a defined engagement of the spindle clutch pawls 52 in the pawl teeth 54 of the seat-belt spindle 5 can take place. A mutual blocking of the spindle clutch pawls 52 is therefore reliably avoided by the synchronization pawl 55. If just a single spindle clutch pawl 52 is used, the synchronization pawl 55 could be omitted.

In FIG. 5, three holes 531 can be seen in the spindle housing 53. Pins which bear planet wheels of the planet wheel gear 71 according to FIG. 1 are inserted into the holes 531. The pins and the planet wheels of the planet wheel gear 71 are not illustrated in FIG. 5.

FIG. 5 also shows a brake shoe 532 which is pressed radially outward by means of a brake shoe spring 533, so that it always bears in a bearing hole of the installation plate 9. The function of the brake shoe 532 is to prevent the spindle clutch housing 53 from chattering in relation to the installation plate 9. By means of the brake shoe 532, manufacturing tolerances in the manufacturing of the spindle clutch housing 53 and of the installation plate 9 are compensated for. The brake shoe spring 533 also has a further function, namely of keeping the synchronization pawl 55 in a disengaged position in relation to the pawl teeth 54; however, when the drive motor 3 is switched on, the force of the brake shoe spring 533 is overcome by the synchronization pawl 55, so that the latter can be inserted into the pawl teeth 54.

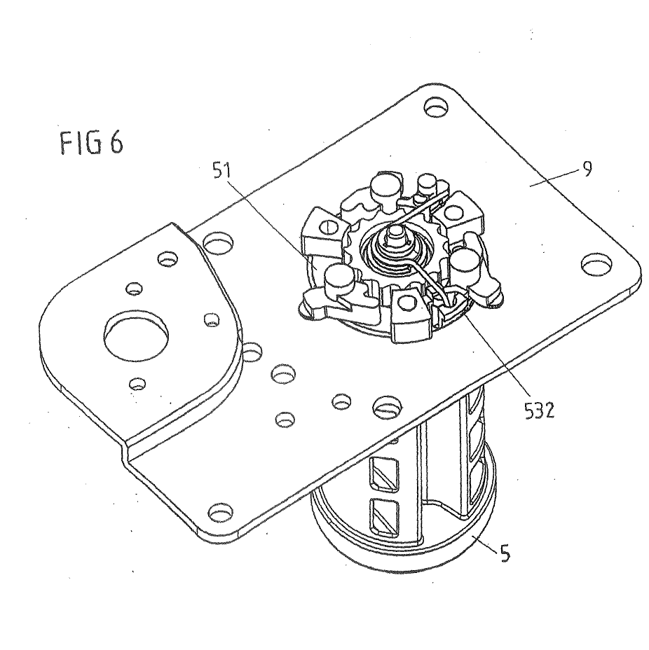

FIG. 6 once again shows the seat-belt spindle 5 together with the spindle clutch 51 after installation on the installation plate 9.

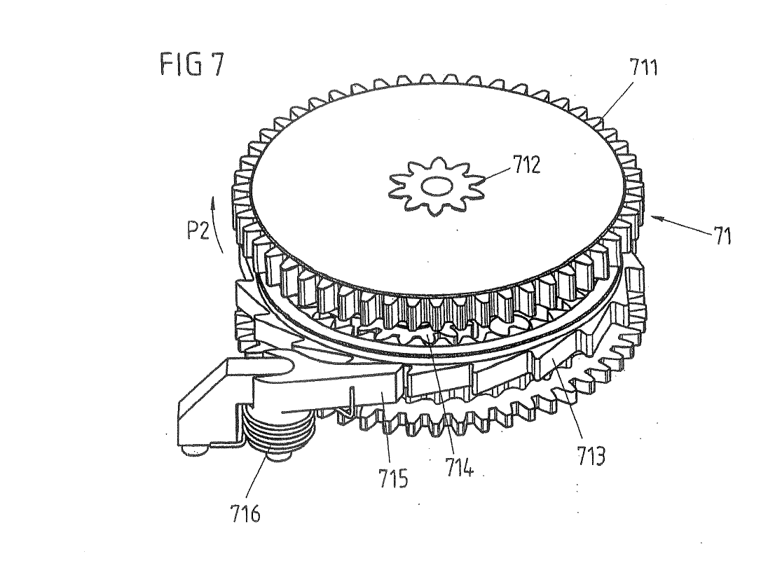

FIG. 7 once again shows the planetary gear 71 according to FIG. 1 in detail. The external sun wheel 711 and the internal sun wheel 712 which is connected thereto and drives three planet wheels of the planetary gear 71 can be seen. Of the three planet wheels, only one planet wheel 714 can be seen in FIG. 7. The planet wheel 714 and the two other planet wheels are held on pins which are held in the holes 531 of the spindle clutch housing 53 according to FIG. 5.

The crown wheel 713 which interacts with a planetary clutch pawl 715 can also be seen in FIG. 7. The planetary clutch pawl 715 has the effect of enabling the crown wheel 713 to be rotated exclusively counter to the direction of rotation P2; in the process, the planetary clutch pawl 715 ratchets along the external teeth of the crown wheel 713. Along the direction of rotation P2, the planetary clutch pawl 715 blocks a rotation of the crown wheel 713.

The planetary clutch pawl 715 is pressed toward the crown wheel 713 by a planetary clutch pawl spring 716, so that the locking effect (already explained) by the planetary clutch pawl 715 is ensured.

The function of the planetary clutch pawl 715 is to perrit the external sun wheel 711, the internal sun wheel 712 and the planet wheel 714 of the planetary gear 71 to revolve without a force transmission to the seat-belt spindle 5 occurring. A revolving of the planetary gear 71 in a manner free from force transmission then occurs if the sliding clutch according to FIG. 1 is engaged and the force transmission takes place along the first force transmission path 6.

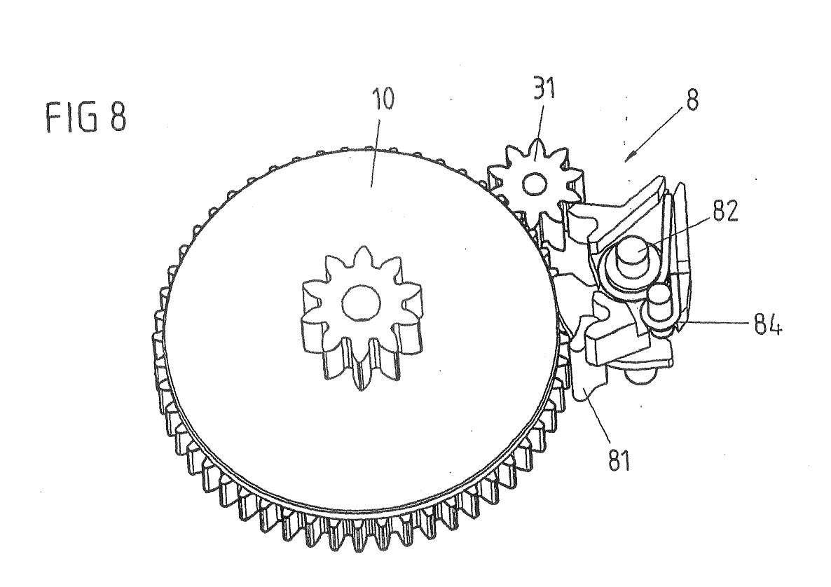

In conjunction with FIGS. 8 to 10, the construction and the operation of the blocking device 8 according to FIG. 1 will now be explained. FIG. 8 shows the latching pawl 81 which is held rotatably on a bearing pin 82. The latching pawl 81 is guided on the bearing pin 82 via an elongated hole 83.

A latching pawl spring 84 is connected to the latching pawl 81. The function of the latching pawl spring 84 is to press the latching pawl 81 toward the connecting gearwheel 10.

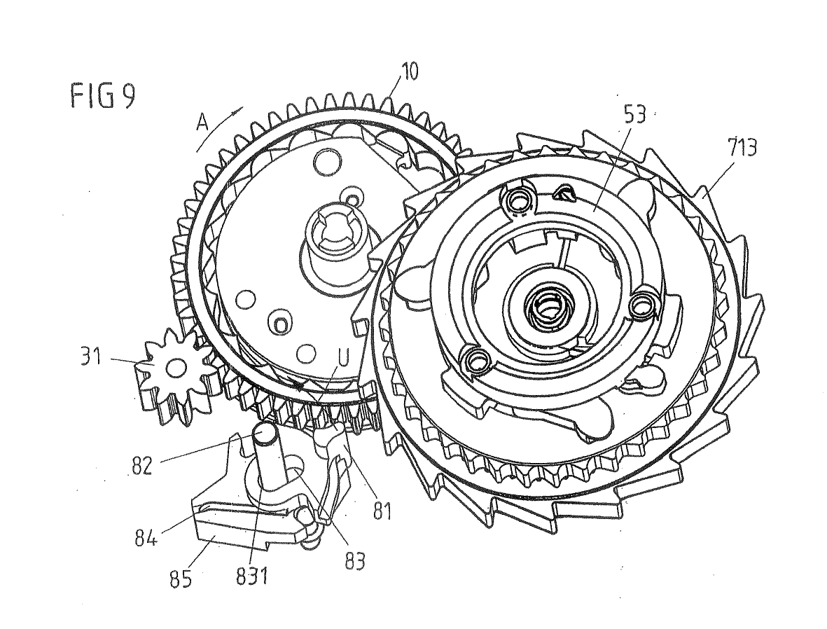

An object of the latching pawl 81 is to keep the seat belt 2 in the tensioned position after the seat belt has been tensioned by the drive motor 3. The latching pawl 81 brings this about by the fact that it prevents the connecting gearwheel 10 from rotating back in the seat-belt-unrolling direction. The latching pawl 81 therefore blocks the connecting gearwheel 10 in the seat-belt-unrolling direction A. This is shown in FIG. 9.

It can also be seen in FIG. 9 that it is possible, owing to the multiplicity of latching teeth on the outside of the connecting gearwheel 10, to keep the seat belt 2 in virtually any position using the latching pawl 81; an undesirable yielding of the seat belt 2 due to play in the blocking device 8 is therefore limited. In the case of the exemplary embodiment, the undesirable yielding of the seat belt 2 is smaller than 1.5 degrees (with regard to the angle of rotation of the seat-belt spindle 5).

In the event of an accident, the seat-belt-extraction force acting on the seat belt 2 will increase severely as soon as the vehicle occupant held by the seat belt 2 presses against the seat belt. In order then to permit the seat belt 2 to yield, so that injuries due to the seat belt are avoided, the latching pawl 81 is pivoted (pivoting direction U) from the first pawl position illustrated in FIG. 9 (“latching pawl 81 faces away from the motor pinion 31”) into a second pawl position (“latching pawl 81 faces the motor pinion 31”) when a predetermined maximum seat-belt-extraction force is exceeded. The predetermined seat-belt-extraction force is preferably between 1000 and 3000 newtons, preferably 2000 newtons (with regard to the seat-belt force on the shoulder of the vehicle occupant).

The unrolling speed of the seat belt can be controlled, for example, with the drive motor 3, since its motor pinion 31 is always in engagement with the connecting gearwheel 10. Thus, by the drive motor 3 being energized in the seat-belt-tensioning direction of rotation, the unrolling of the seat belt can be braked.

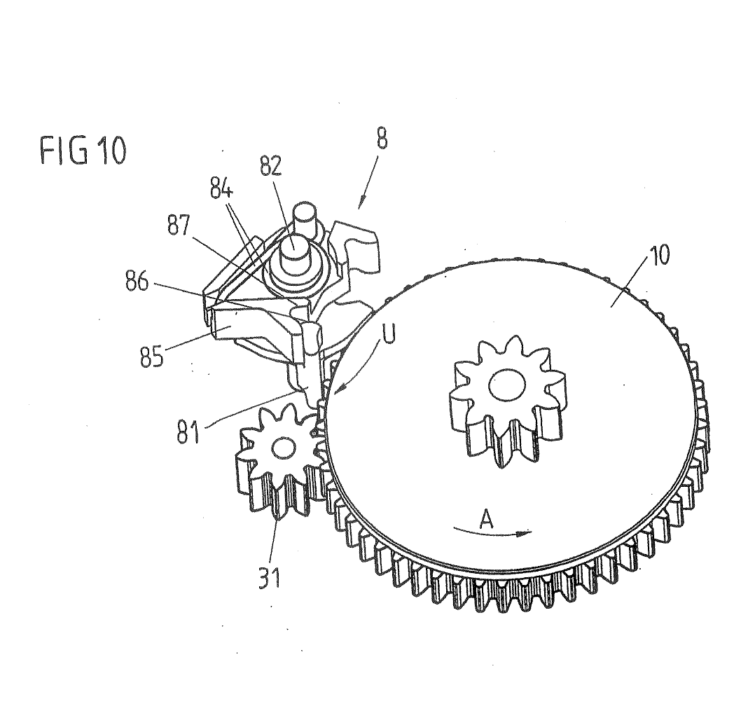

A pivoting of the latching pawl 81 is possible because the latching pawl 81 is held in an elastically resilient manner in the elongated hole 83 by the latching pawl spring 84. When the predetermined seat-belt-extraction force is exceeded, the latching pawl 81 is therefore pressed away from the connecting gearwheel 10 counter to the restoring force of the latching pawl spring 84. This permits the latching pawl 81 to pivot or flip over so that it is transferred into the second pawl position illustrated in FIG. 10 (pivoting direction U in FIGS. 9 and 10). The latching pawl 81 pivots together with a latching block 85. This takes place as follows: when the predetermined seat-belt-extraction force is reached, the latching pawl 81 is pressed in the direction of the latching block 85; in the process, a cam 86 of the latching pawl 81 strikes against a stop 87 of the latching block 85. As a result, the latching block 85 then pivots counterclockwise (cf. FIG. 8) about the bearing pin 82, so that the latching pawl 81 is released for pivoting over according to the pivoting direction U and the pivoting-over takes place.

In the second pawl position illustrated in FIG. 10 (“latching pawl 81 faces the motor pinion 31”), the latching pawl 81 no longer prevents an unrolling of the seat belt 2, with the result that the seat belt 2 can unroll when the motor drive 3 is switched off; in the second pawl position, the latching pawl only slides along the run-on collar of the connecting gearwheel 10. This makes it possible to unroll the seat belt 2 in a specific manner by means of further devices, for example a torsion bar, such that there is a reduced seat-belt-restraining force on the vehicle occupant.

In conjunction with FIGS. 9 and 10, it should be mentioned that FIG. 9 shows the connecting gearwheel 10 from its lower side and FIG. 10 shows it from its upper side. In addition, the crown wheel 713 and the spindle clutch housing 53 can be seen from the lower side in FIG. 9.

Since the components of the seat-belt tensioner 1 have been explained in detail in conjunction with FIGS. 1 to 10, the interaction of the components in the event of a vehicle accident will now be explained once again for better comprehension:

In the event of a vehicle accident or a situation shortly before an accident, the seat-belt tensioner 1 (for example, as shown in FIG. 1) is activated. In the case of an activation of this type, the drive motor 3 is put into operation so that it retracts and tensions the seat belt 2. The drive motor 3 is therefore operated in the seat-belt-tensioning direction of rotation.

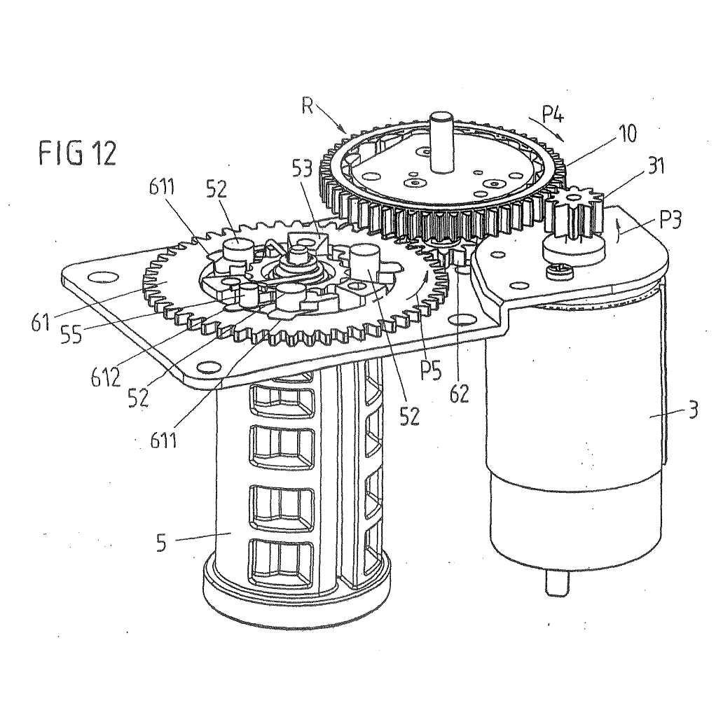

The motor pinion 31 therefore rotates according to the direction of rotation P3 according to FIG. 12. Owing to this rotation of the motor pinion 31, the connecting gearwheel 10 is rotated along the direction of rotation P4. The coupling wheel 62 therefore drives the spindle clutch toothed ring 61 in the direction of rotation P5. Owing to the rotation of the spindle clutch toothed ring 61, the synchronization pawl 55 will be inserted into the pawl teeth 54 of the seat-belt spindle 5 and will bring about a defined position between the spindle clutch toothed ring 61 and the pawl teeth 54 of the seat-belt spindle 5. Subsequently, the three spindle clutch pawls 52 will then be inserted into the pawl teeth 54 of the seat-belt spindle 5, so that the spindle clutch 51 is transferred from the initially disengaged position into the engaged position.

The function of the three spindle clutch pawls 52 is therefore to bring about a rotational connection between the drive motor 3 and the seat-belt spindle 5 during rotation of the motor pinion 31. Before the drive motor 3 is activated, the spindle clutch 51 is still in the uncoupled state, so that the seat-belt spindle 5 can rotate entirely freely of the automatic gear 4. The automatic gear 4 and the drive motor 3 are therefore separated from each other before an accident or a hazardous situation occurs, with the result that the seat belt 2 can be unrolled from the seat-belt spindle 5 without great force and therefore very comfortably. Only in the event of an accident or a hazardous situation is the spindle clutch 51 activated, by the drive motor 3 being switched on.

After the drive motor 3 is switched on, the force transmission to the seat-belt spindle 5 therefore first of all takes place via the motor pinion 31, the connecting gearwheel 10, the spindle clutch toothed ring 61 and the spindle clutch 51; i.e. the first force transmission path 6 according to FIG. 1 is activated. The transmission ratio of the first force transmission path or of the “first speed” of the automatic gear 4 is, for example, 26:1. This means that the seat-belt spindle 5 rotates through a single revolution during 26 revolutions of the drive motor 3.

As soon as the drive motor 3 is activated and the spindle clutch toothed ring 61 is rotated according to the direction of rotation P5 according to FIG. 12, the seat belt 2 is retracted on the seat-belt spindle 5, so that a tensioning of the seat belt occurs. With increasing tensioning of the seat belt, the force acting on the automatic gear 4 and therefore the sliding clutch R becomes ever greater. As soon as the tensioning force in the shoulder region of the vehicle occupant has reached a force of, for example, 200 to 250 newtons, the sliding clutch R explained in conjunction with FIG. 2 will disengage. The sliding clutch R can only be seen from the lower side in FIG. 12.

If the “first” speed is active, the planetary gear 71 according to FIG. 1 is rotated by the connecting gearwheel 10 and initially revolves in a manner free from force transmission. In this case, the revolving of the planet wheel gear 71 in a manner free from force transmission is possible, since the crown wheel 713 of the planetary gear 71 can rotate freely at the same time counter to the arrow direction P2 according to FIG. 7.

If the sliding clutch R according to FIG. 2 is now disengaged, the spindle clutch toothed ring 61 is no longer driven by the coupling wheel 62. This results in the crown wheel 713 now being rotated along the direction of rotation P2 according to FIG. 7, but this is prevented by the planetary clutch pawl 715. Owing to the blocking of the crown wheel 713, a force transmission by the planetary gear 71 now occurs, so that the seat-belt spindle 5 is now driven by the second force transmission path 7. In the second force transmission path 7—i.e. in the “second speed” of the automatic gear 4—the transmission ratio is, for example, 127:1. The planetary gear 71 therefore multiplies the transmission ratio with respect to the first speed of the automatic gear 4 by the factor 4.8.

Owing to the shifting of the automatic gear 4 into the second speed, the tensioning force of the seat-belt tensioner 1 is raised, with the result that the seat belt 2 is tensioned with a great tensioning force. As soon as a predetermined tensioning force is reached and the tensioning operation is finished, the drive motor 3 is switched off in order to prevent a further load on the electric system of the vehicle battery by the drive motor 3. In order then to avoid the seat belt 2 from being able to unroll again from the seat-belt spindle 5, the connecting gearwheel 10 has to be blocked in the tensioning position. This takes place by means of the blocking device 8 and the latching pawl 81 which is initially in the first pawl position illustrated in FIGS. 8 and 9. In the first pawl position, the connecting gearwheel 10 can rotate in the seat-belt-tensioning direction whereas an unrolling of the seat belt 2 from the seat-belt spindle 5 is prevented. The latching pawl 81 therefore results in the tensioning force of the seat belt 2 being kept.

If, in the event of an accident, the vehicle occupant is pressed against the seat belt 2, the restraining force exerted by the seat belt 2 will rise severely. In order to bring about a yielding of the seat belt 2 and a restricting of the restraining force, the blocking device 8 according to FIG. 1 has to be switched off if a predetermined maximum seat-belt-extraction force is exceeded. This takes place in the case of the seat-belt tensioner 1 by the latching pawl 81 being pivoted from the first pawl position illustrated in FIG. 9 into the second pawl position illustrated in FIG. 10. The pivoting of the latching pawl 81 is possible owing to the elongated hole 83. Owing to the latching pawl 81 being flipped or pivoted over into the second pawl position, an unrolling of the seat belt 2 from the seat-belt spindle 5 is subsequently possible. The further unrolling of the seat belt 2 from the seat-belt spindle 5 is ensured by further safety devices, for example a torsion bar which is arranged in the interior of the seat-belt spindle 5.

The seat-belt tensioner 1 according to FIG. 1 is of completely reversible design; this means that it can be reset into its starting state after a first commissioning. This will be explained in detail below.

Two different accident scenarios are differentiated below:

a) “Predetermined seat-belt-extraction force has been exceeded”:

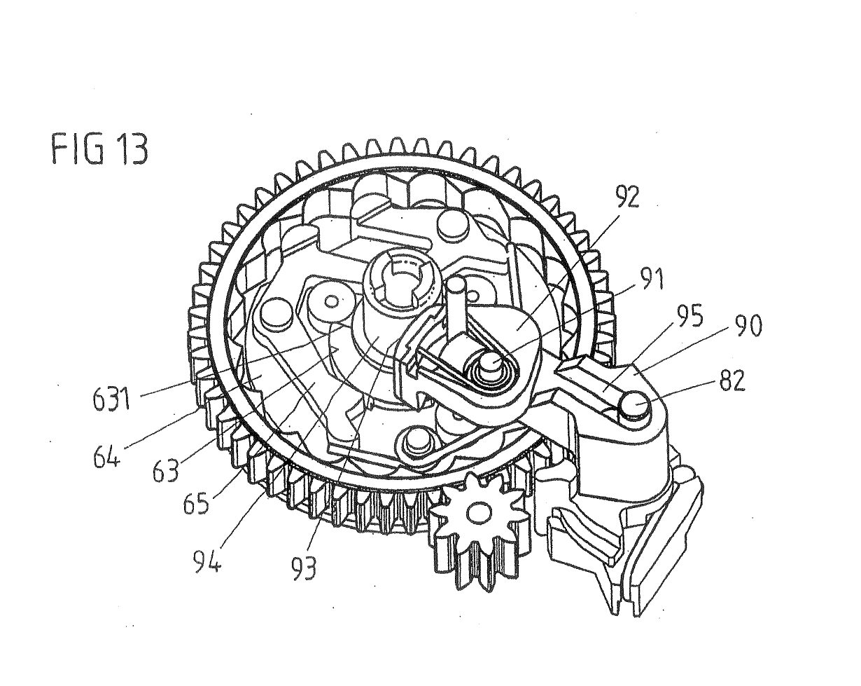

In the case of this accident scenario, after the seat belt has been tensioned, the predetermined seat-belt-extraction force is exceeded, so that the latching pawl 81 is transferred into its second pawl position, as has been explained above in conjunction with FIGS. 8 and 9. The resultant starting position of the latching pawl 81 and of the disk cam 63 and the sliding clutch pawl 65 are once again shown in FIG. 13.

FIG. 13 also shows a connecting rod 90 which is connected rotatably to a friction element 92 via a friction element bearing pin 91. A friction surface 93 (e.g. rubber) which bears against a stem 94 of the disk cam 63 is arranged on the outside of the friction element 92. The connecting rod 90 is guided on the bearing pin 82 via an elongated hole 95. The position of the friction surface 93 relative to the stem 94 arises owing to the above-explained flipping of the latching pawl 81 over from the first pawl position into the second pawl position.

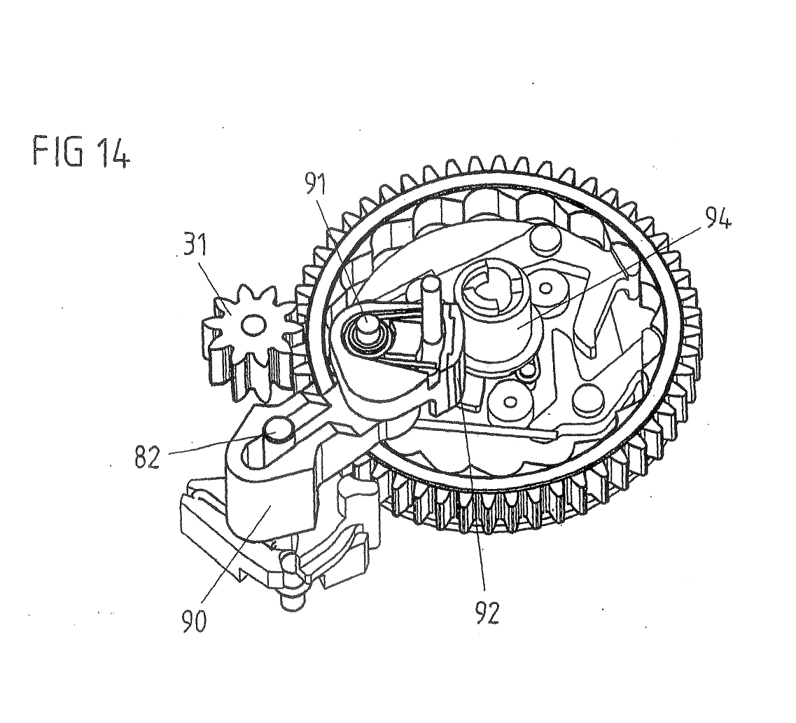

Since, in the case of a rotation of the motor pinion 31—owing to the planetary gear—the coupling wheel 62, the pawl carrier 64 and the disk cam 63 with the stem 94 will also passively rotate at the same time, the friction surface 93 and therefore the friction element 92 are pivoted away and the connecting rod 90 is displaced in the elongated hole 95 (cf. FIG. 13). If the drive motor is now operated once again in the tensioning direction, then the latching pawl 81 is pivoted back into its first pawl position (FIG. 14). As a result, the stem 94 and therefore the disk cam 63 are rotated in relation to the pawl carrier 64 counter to the spring force of the torsion spring 642, so that the cam 631 is rotated back into the position illustrated in FIG. 2. The sliding clutch pawl 65 is therefore released again for engagement with the connecting gearwheel 10.

During further operation of the drive motor 3 in the seat-belt-tensioning direction, the sliding clutch pawl 65 will then be inserted into the connecting gearwheel 10, so that the “first” speed of the automatic gear 4 is activated. Since the latching pawl 81 has been “flipped over” or shifted by the drive motor 3 from its second pawl position back into its first pawl position, a blocking of the seat belt 2 after tensioning of the seat belt has taken place is possible.

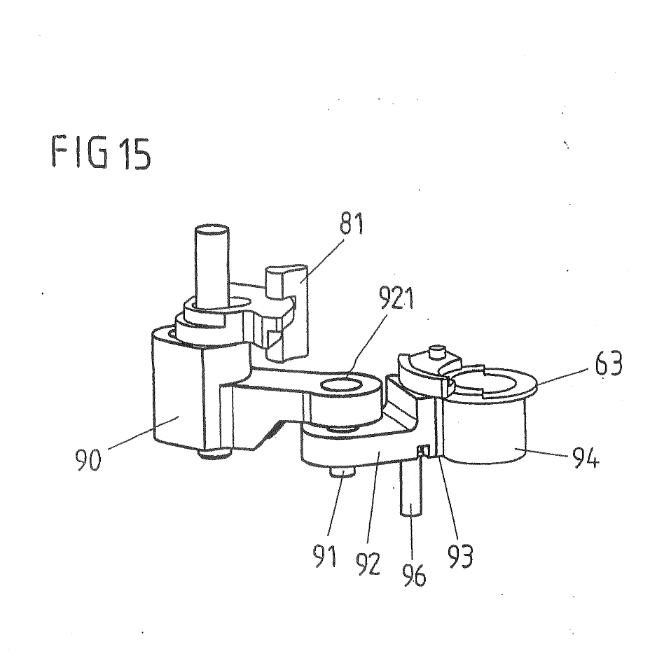

For better comprehension of the operation, FIG. 15 shows the connecting rod 90, a connecting rod pin 921, the friction element 92 and the latching pawl 81 in detail. A stop pin 96 which is fitted fixedly on the installation plate 9 is also seen. The stop pin 96 is guided in a slotted guide of the friction element 92 and, in end positions of the friction element 92, strikes against, for example, spring-mounted stops of the friction element 92.

b) “Predetermined seat-belt-extraction force has not been exceeded”:

If the predetermined seat-belt-extraction force is not exceeded, the latching pawl 81 is consequently not flipped over into the second pawl position. The latching pawl 81 has therefore remained in its first latching position, so that the position of the latching pawl 81 and the position of the connecting rod 90 and of the friction element 92 correspond to the position shown in FIG. 14.

In order now to move the latching pawl 81 into the non-blocking, second pawl position and to relax the seat belt, the driving motor 3 is first of all operated in the seat-belt-unrolling direction, so that the latching pawl 81 and the connecting rod 90 and the friction element 92 are transferred into the positions according to FIG. 13. The seat-belt tensioner can therefore be activated again.

For renewed tensioning of the seat belt, the drive motor 3 is operated in the seat-belt-tensioning direction of rotation, with the result that the sequence of movement according to above section a) (“Predetermined seat-belt-extraction force has been exceeded”) is run through. As a result, the automatic gear 4 is again shifted into the “first speed”,so that the first force transmission path 6 is active. The seat-belt tensioner is therefore ready for use for further tensionings of the seat belt.

During an operation of the drive motor 3 in the seat-belt-unrolling direct, the spindle clutch toothed ring 61 is furthermore likewise rotated owing to the corresponding rotation of the connecting gearwheel 10, so that the spindle clutch pawls 52 (explained in detail in conjunction with FIG. 5) can be rotated out of the pawl teeth 54 of the seat-belt spindle 5 when there is freedom from load. The same applies to the synchronization pawl 55 which is likewise rotated out of the pawl teeth 54 of the seat-belt spindle 5. By rotation out of the three spindle clutch pawls 52 and the synchronization pawl 55, the spindle clutch 51 is disengaged, so that the seat-belt spindle 5 can freely rotate; the seat-belt spindle 5 is therefore separated both from the planetary gear 71 and therefore from the second force transmission path 7 and also from the first force transmission path 6. The synchronization pawl 55 and subsequently the spindle clutch pawls 52 are re-engaged only when the drive motor rotates again in the seat-belt-tensioning direction of rotation, and the spindle clutch toothed ring 61 is driven in the direction illustrated in FIG. 5 by the designation S.

If, after the seat belt has been tensioned and the blocking device 8 has been activated, an accident does not occur, contrary to expectations, because the hazardous situation could be averted, then the seat belt 2 has to be able to be loosened again. This takes place in the case of the seat-belt tensioner 1—as has already been explained above in conjunction with the re-engagement of the sliding clutch R—likewise by the drive motor being briefly operated in the seat-belt-unrolling direction. The connecting gearwheel 10 causes the latching pawl 81 to be “flipped over” or shifted from its first (blocking) pawl position into its second pawl position, so that the seat belt can unroll. The unrolling speed of the seat belt can be controlled, for example, with the drive motor 3, since its motor pinion 31 is always in engagement with the connecting gearwheel 10. Thus, by energizing the drive motor 3 in the seat-belt-tensioning direction of rotation, the unrolling of the seat belt can be braked.

As already mentioned, in the case of an operation of the drive motor 3 in the seat-belt-unrolling direction, when there is freedom from load the spindle clutch 51 is deactivated, so that the seat belt is separated from the automatic gear 4. Within the context of the latching pawl 81 flipping over from the first pawl position into the second pawl position, the seat-belt force is moreover not increased, so that the occurrence of the otherwise customary “release peak” is avoided; i.e. the switching off of the tensioning of the seat belt is associated with no further increase in the seat-belt-restraining force for the vehicle occupant.

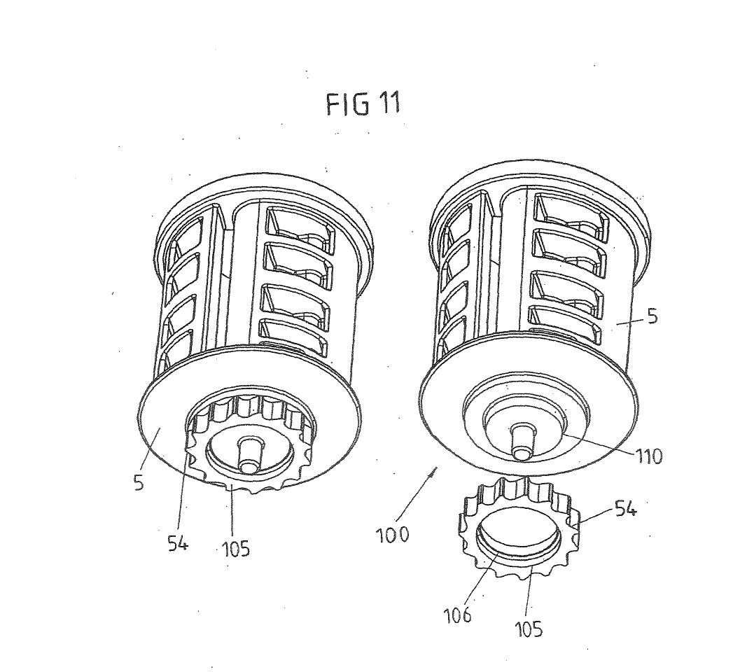

Moreover, an overload clutch can be arranged between the pawl teeth 54 of the seat-belt spindle 5 and the seat-belt spindle 5; FIG. 11 shows an exemplary embodiment of such an overload clutch. The overload clutch 100 according to FIG. 11 connects the seat-belt spindle 5 and the automatic gear 4 to each other. The overload clutch 100 has an overload clutch ring 105, the external teeth of which form the pawl teeth 54 of the seat-belt spindle 5 and the inner surface of which forms an internal taper 106. In addition, the overload clutch 100 forms an external taper 110 which is connected, for example integrally, to the seat-belt spindle 5.

The function of the internal taper 106 and of the external taper 110 is to protect the automatic gear 4 according to FIG. 1. As soon as the seat-belt spindle 5 applies a torque which exceeds a predetermined maximum torque to the overload clutch 100, the overload clutch 100 will interrupt the rotational connection between the seat-belt spindle 5 and the automatic gear 4 by means of a slip.

The interruption in the coupling connection is based on the severing of the force-locked connection between the external taper 110 and the internal taper 106; this is because, when the predetermined maximum torque is exceeded, the external taper 110 will “slide” in the internal taper 106.

The maximum torque is preferably dimensioned so that the latching pawl 81 does not flip over from the first pawl position into the second pawl position. The latching pawl therefore remains in the first pawl position after a tensioning of the seat belt and is only brought by the drive motor 3 into the second pawl position during operation in the seat-belt-unrolling direction, with the spindle clutch 51 subsequently being disengaged.

In addition to the sliding clutch pawl 65, there can moreover be a second sliding clutch pawl 69. The function of the second sliding clutch pawl 69 is to assist the first sliding clutch pawl 65 in the force transmission. The second sliding clutch pawl 69 is arranged so that it is engaged and disengaged together with the first sliding clutch pawl 65.

The priority application German Patent Application No. 10 2004 012 173.4, filed Mar. 9, 2004, including the specification, drawings, claims, and abstract, is incorporated by reference herein in its entirety.

What is claimed is:

1. A seat-belt tensioner for a seat-belt system comprising:
a drive motor and a seat belt spindle, wherein a gear is connected to the drive motor and the seat-belt spindle;
wherein an overload clutch is arranged between the gear and the seat-belt spindle and is configured to transmit torques up to a predetermined maximum torque and, when the maximum torque is exceeded is configured to disengage.

2. The seat-belt tensioner of claim 1, wherein the overload clutch has two coupling elements which, in the engaging state of the overload clutch, form a force-locked connection between the gear and the seat-belt spindle and, in the disengaging state of the overload clutch, have a slip.

3. The seat-belt tensioner of claim 1, wherein the gear is automatic and has a first force transmission path for a first speed with a first transmission ratio and a second transmission path for a second speed with a transmission ratio which is larger than the first transmission ratio.

4. The seat-belt tensioner of claim 3, wherein the automatic gear has a connecting gearwheel which is driven by the drive motor of the seat-belt tensioner and interacts both with the first and with the second force transmission path.

5. The seat-belt tensioner of claim 3, wherein the first force transmission path comprises a sliding clutch which disengages when a predetermined switching-off moment is exceeded, and in that, as a consequence, the second transmission path is activated.

6. The seat-belt tensioner of claim 5, wherein the sliding clutch includes a pawl carrier which is mounted rotatably coaxially with the connecting gearwheel, and a sliding clutch pawl is mounted pivotably on the pawl carrier so that it can be pivoted into a coupling position and into a disengaging position.

7. The seat-belt tensioner of claim 6, wherein the sliding clutch pawl couples the pawl carrier and the connecting gearwheel in the seat-belt-tensioning direction of rotation when the sliding clutch pawl is in a coupling position, and when the sliding clutch pawl is in a disengaging position the sliding clutch pawl is ineffective with regard to the coupling between the connecting gearwheel and the pawl carrier.

8. The seat-belt tensioner of claim 7, wherein the sliding clutch includes a disk cam which prevents the sliding clutch pawl, after the sliding clutch pawl has reached the disengaging position, from automatically passing again into the coupling position.

9. The seat-belt tensioner of claim 8, wherein—as soon as the sliding clutch pawl reaches the disengaging position—the disk cam is rotated by a spring into a blockade position in which the disk cam holds the sliding clutch pawl in the disengaging position.

10. The seat-belt tensioner of claim 3, wherein the seat-belt spindle and the automatic gear are connected by a spindle clutch.

11. The seat-belt tensioner of claim 10, wherein the spindle clutch engages when the drive motor rotates in the seat-belt-tensioning direction of rotation and disengages when the drive motor rotates in the seat-belt-unrolling direction of rotation.

12. The seat-belt tensioner of claim 10, wherein the spindle clutch has spindle clutch pawls arranged so that they are inserted into pawl teeth of the seat-belt spindle as soon as the spindle clutch toothed ring rotates in the seat-belt-tensioning direction of rotation, as a result of which the seat-belt spindle and the spindle clutch toothed ring are coupled to each other in a rotationally fixed manner, and/or the spindle clutch pawls are arranged so that they are pivoted out of the pawl teeth of the seat-belt spindle when the spindle clutch toothed ring rotates in the seat-belt-unrolling direction, as a result of which the connection between the seat-belt spindle and the spindle clutch toothed ring is separated.

13. The seat-belt tensioner of claim 12, wherein the spindle clutch has a synchronization pawl which engages in the pawl teeth of the seat-belt spindle, as a result of which the seat-belt spindle and the spindle clutch toothed ring are aligned with each other before the spindle clutch pawls of the spindle clutch engage in the pawl teeth of the seat-belt spindle.

14. The seat-belt tensioner of claim 13, wherein the spindle clutch pawls and the synchronization pawl are held pivotably in a spindle clutch housing.

15. The seat-belt tensioner of claim 3, wherein the automatic gear has a planetary gear arranged in the second force transmission path.

16. The seat-belt tensioner of claim 15, wherein the planetary gear revolves in a manner free from force transmission when the sliding clutch is engaged and, when the sliding clutch is disengaged, is used for the force transmission and provides the second speed of the automatic gear.

17. The seat-belt tensioner of claim 1, wherein the seat-belt tensioner has a blocking device which blocks the seat-belt spindle in the tensioned position after the end of the tensioning operation.

18. The seat-belt tensioner of claim 17, wherein the blocking device is configured so that it can be released without increasing the seat-belt-restraining force acting on the vehicle occupant.

19. The seat-belt tensioner of claim 17, wherein the blocking device can be released by the drive motor of the seat-belt tensioner.

20. The seat-belt tensioner of claim 17, wherein the blocking device is released by the drive motor of the seat-belt tensioner by the drive motor being operated in the seat-belt-unrolling direction.

21. The seat-belt tensioner of claim 17, wherein the blocking device has a latching pawl which can be brought into a first and into a second pawl position, the first pawl position blocking the seat-belt spindle in the seat-belt-unrolling direction, and the second pawl position releasing the seat-belt spindle in the seat-belt-unrolling direction.

22. The seat-belt tensioner of claim 21, wherein the latching pawl is held pivotably and resiliently so that it can be pivoted back from the second pawl position into the first pawl position with the aid of the driving force of the drive motor.
